(19) United States
(12) Patent Application Publication
(10) Pub. No.: US 2014/0193773 A1
(43) Pub. Date: Jul. 10, 2014

(54) Application Device for Dental Compositions

(71) Applicants: Philipp Rolle, Neumunster (DE); Frederic Sobina, Kiel (DE)

(72) Inventors: Philipp Rolle, Neumunster (DE); Frederic Sobina, Kiel (DE)

(73) Assignee: Transcodent GmbH & Co. KG, Kiel (DE)

(21) Appl. No.: 14/233,905

(22) PCT Filed: Jun. 20, 2012
(86) PCT No.: PCT/EP2012/061788

§ 371 Date: Jan. 21, 2014

(30) Foreign Application Priority Data
Jul. 22, 2011 (DE) 10 2011 079 682.7

(51) Int. Cl. A61C 19/06

(52) U.S. Cl. CPC A61C 19/063
USPC 433/83

(57) ABSTRACT

An application device for dental compositions. At the rear end, the application device is provided with a connection for a discharge container. A channel extends from the connection to a channel opening arranged at the front end. Flat protrusions are formed at the front end, which enclose therebetween a receiving space for the dental composition. Using the receiving space, the excess dental composition can be taken up again and removed.

### BACKGROUND

The invention relates to an application device for dental compounds. On a rear end of the application device, a connector for a discharging container is provided. A duct extends from the connector up to a duct opening which is arranged on the front end of the application device.

Such application devices can be used to dispense the dental compound contained in a discharging container in a targeted manner. To this end, the application device is connected to the discharging container via the connector, such that the duct of the application device is connected to an exit opening of the discharging container. Dental compound, which is dispensed from the discharging container, moves through the duct and exits at the front end of the application device.

Application devices, in which the front end is provided with fibers, are known. The fibers may be used to distribute the dispensed dental compound on a face or to shape the dental compound in a specific way. Such fibers have the disadvantage that it is barely possible to influence the dosing of the dental compound to be distributed.

### SUMMARY

An application device which offers more flexibility when applying the dental compound is provided. Flat protrusions, which enclose between them a receiving space for the dental compound, are configured on the front end of the application device.

First, some terminology is explained. A receiving space in the sense of the invention is delimited on two sides by faces of the protrusions. Between the protrusions there are open regions in which the receiving space merges without further delimitation with the surroundings. The protrusions are preferably arranged in a substantially parallel manner to one another.

The front end comprises the front end side and the portion of the application device which adjoins said end side. The term dental compound comprises pasty and liquid substances.

The application device has the advantage that the flat protrusions can be utilized to dispense and distribute the dental compound in a targeted manner. Moreover, it is also possible to retrieve in the receiving space dental compound which has been excessively distributed. On account of this, user friendliness is increased and it becomes possible to deploy the application device in a flexible manner.

It is of advantage if the dental compound can be repeatedly received and discharged again in the receiving space. For this purpose, the protrusions may be elastically configured, such that the volume of the receiving space can be modified by pressure acting on the protrusions. In a manner corresponding to the reduction of volume, dental compound exits again via the open regions of the receiving space. This can be utilized, for example, when too much dental compound has initially been dispensed at one point and too little dental compound at another point.

For the application device to be manipulated in this way, it is necessary for a certain force to be able to be transmitted to the front end of the application device. To this end, a support structure, which extends from the rear end up to the front end, may be provided. The support structure preferably has a higher rigidity than the protrusions, such that the protrusions can be deformed by a force which is transmitted via the support structure.

The support structure may be configured such that it surrounds the duct, i.e., such that the duct extends in the interior of the support structure. The support structure may be composed of metal and have the shape of, for example, a cannula. The flat protrusions may be composed of plastic and be molded on the metal. Alternatively, the application device may be entirely composed of plastic. The application device may be manufactured as an injection-molded part, wherein the support structure may be composed of a more rigid plastic material than the flat protrusions.

In the case of the support structure being composed of metal, it may suffice if the plastic material of the flat protrusions is connected only to the front end of the support structure. In order to avoid that great forces act on the connection between the plastic and the metal when squeezing out the dental compound through the duct, it may be provided that the duct opening is arranged in the metallic support structure.

The duct opening may be oriented laterally in relation to the longitudinal direction of the duct. In this case, the dental compound exits through the duct opening without any prior contact with the flat protrusions. The flat protrusions are used for the subsequent distribution of the dental compound. It is also possible for the duct to transition from the metallic support structure into the plastic material and for the duct opening to be formed by the plastic material.

In an alternative embodiment the duct opening is arranged on a front end face of the application device. The flat protrusions may extend in the radial direction in relation to a longitudinal axis which extends from the rear end to the front end of the application device. In this embodiment the dental compound also exits from the application device without any prior contact with the flat protrusions. The duct opening thus opens out outside of the receiving space.

It may also be provided that the duct opening opens out into a receiving space. The dental compound exiting from the duct opening in this case initially fills up the receiving space. The dental compound can then be distributed in the desired way from the receiving space. In the event that the protrusions extend in the radial direction, the duct opening is preferably arranged laterally in relation to the longitudinal direction of the duct. The duct opening may be oriented perpendicularly to the longitudinal direction of the duct. It is also possible for the duct opening to enclose a comparatively small angle with the longitudinal direction of the duct.

Embodiments in which the receiving space is arranged in an extension of the application device are also provided. To this end, the flat protrusions may extend forward from the front end of the support structure. In this case, a duct opening, which is arranged on the end face of the support structure, opens into the receiving space.

In the simplest case, two flat protrusions extend forward from the front end of the support structure, wherein the two protrusions are oriented in a substantially parallel manner to one another. A fan-like arrangement having a plurality of receiving spaces, which are arranged next to one another, is also possible. Also other embodiments, those in which the flat protrusions for instance collectively form a tulip-like shape or in which the flat protrusions intersect one another, are possible.

It may be that the application device comprises merely one duct opening. The duct opening may open out either within the receiving space or outside of the receiving space (or the receiving spaces, respectively, in the event that a plurality are provided). Alternatively, the application device may be supplied with a plurality of duct openings. The duct openings may be arranged such that duct openings open out into a plurality of receiving spaces. It is also possible for part of the duct openings to open out into one receiving space and for another part of the duct openings to open out outside of the receiving spaces.

The transport container, to which the application device can be connected, may be provided with a dispensing tip which toward the front is conically tapered. The dispensing tip may be provided with an exit opening for the dental compound. The connector of the application device, via which the connection to the transport container is established, may comprise a conically tapered recess which is adapted to the dispensing tip. The application device may then, with the connector, be plugged onto the dispensing tip and is retained there by frictional locking. The dental compound can pass directly from the exit opening into the duct of the application device.

In its simplest embodiment, the application device has merely two protrusions and one receiving space, which is arranged between the protrusions. More latitude when receiving excess dental compound may be achieved by a plurality of receiving spaces. The receiving spaces may be arranged next to one another such that more than two flat protrusions are oriented substantially parallel to one another, such that a central flat protrusion separates two adjacent receiving spaces from one another. The distance between two flat protrusions is preferably smaller than the greatest height extent of the protrusions. In this case the protrusions may be deformed such that they come into contact with one another.

The protrusions may be designed such that they extend around the duct in a disk-like manner. This has the advantage that the dentist need not pay attention to the angular alignment of the application device. The protrusions may have identical dimensions, such that the protrusions collectively form a cylindrical contour. It is also possible for the protrusions to become smaller in the direction of the front end, or the rear end, respectively, such that the contour formed by the protrusions tapers off in that direction.

The application device is intended to serve, in particular, for depositing dental compounds into cavities of teeth to be filled. To this end, the largest diameter of the contour defined by the flat protrusions is preferably between 1 mm and 5 mm, further preferably between 2 mm and 3 mm.

In particular in the event that the dental compound to be processed is of comparatively low viscosity, it is desirable that the dental compound is well retained in the receiving space. For this purpose, a first receiving space and a second receiving space may be arranged in an offset manner against one another, such that a protrusion of the first receiving space is arranged in the lateral extension of the second receiving space and thus contributes toward retaining the dental compound in a secure manner in the second receiving space. In the case of this embodiment the receiving spaces may also be designed so as to extend around the duct in a collectively fully encircling manner, such that the angular alignment of the application device can again be freely selected.

When viewing the projection of the protrusions of the first and of the second receiving spaces, the protrusions of the first receiving space may have a lateral distance from the protrusions of the second receiving space. In order to enable a use of the application device which is independent of the angular alignment, it is however preferable if, in the projected view, the protrusions of the first receiving space terminate with the protrusions of the second receiving space.

In order to further improve retention of the dental compound, an intermediate protrusion may be arranged within a receiving space, the surface area of said intermediate protrusion being small in comparison with the surface area of adjacent protrusions. In the case that the intermediate protrusion protrudes farther in the radial direction than adjacent protrusions, said intermediate protrusion can be readily utilized for distributing dental compound, which has been dispensed from the receiving spaces, on a face.

### BRIEF DESCRIPTION OF THE DRAWINGS

The invention is explained in the following in an exemplary manner with reference to the appended drawings by means of advantageous embodiments, in which:

FIG. 1 shows a first embodiment of an application device;

FIG. 2 shows a second embodiment of an application device;

FIG. 3 shows a third embodiment of an application device;

FIG. 4 shows an enlarged illustration of the front end of an application device on a further embodiment of the invention; and

FIG. 5 shows the view from FIG. 4, wherein a duct opening is highlighted.

### DETAILED DESCRIPTION

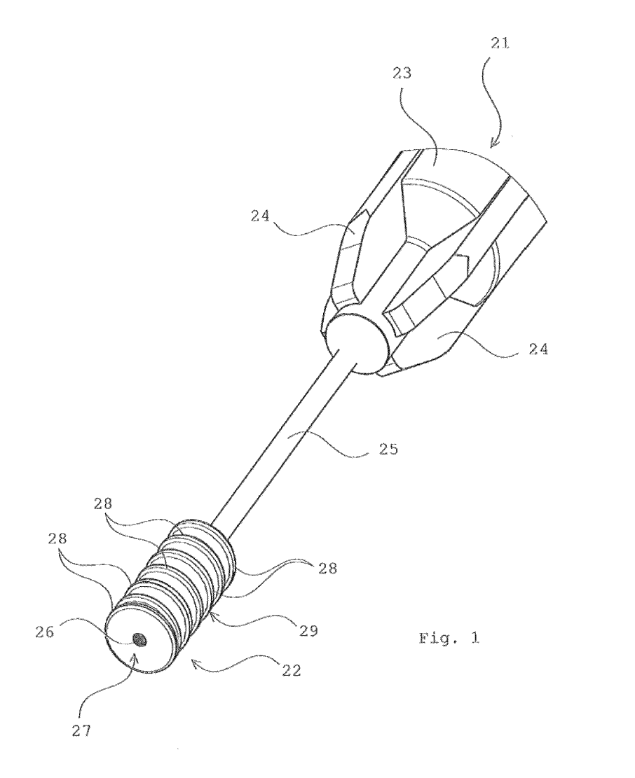

An application device as shown in FIG. 1 extends from a rear end 21 up to a front end 22. A cap-shaped structure, which encloses a conical recess not visible in FIG. 1, is configured on the rear end 21. The recess serves as a connector 23 for connecting the application device to a discharging container (not shown).

On its outer side the cap-shaped structure is provided with a plurality of protrusions 24 which are distributed over the circumference. The dentist can grip the protrusions in order to plug the application device onto the discharging container, or to pull it off from the latter, respectively. A shaft 25, which points in the direction of the front end 22 of the application device, adjoins the cap-shaped structure.

A duct 26, which extends from the rear end 21 up to a duct opening 27 opening out on the front end 22, is configured in the interior of the shaft 25. The duct opening 27 opens out outside of the receiving spaces. On the front end, the shaft 25 is surrounded by flat protrusions 28 which extend in the shape of disks around the shaft 25. Two flat protrusions 28 enclose in each case between them one receiving space 29. The receiving spaces 29 extend likewise around the shaft 25.

When dental compound is introduced at the rear end into the duct 26, said dental compound can move through the duct 26 up to the duct opening 27 and exit there. The dentist positions the duct opening 27 such that the dental compound is directly deposited in the region of application. The dentist estimates the total amount of dental compound that will be required and dispenses this amount through the duct opening 27. Subsequently the dentist uses the protrusions 28 in order to distribute the dental compound in the desired way on a face or to fashion it in the desired way. The shaft 25 acts here as a support structure via which a force, which is adequate for this purpose, can be transmitted to the front end 22 of the application device.

Should it transpire during distributing or during fashioning that too much dental compound has been dispensed, the excess dental compound can be retrieved again by pushing the protrusions 28 in the radial direction into the excess dental compound. On account of this the dental compound reaches the receiving spaces 29 and is retained there by the protrusions 28. Another region of the protrusions 28 is now preferably used for distributing or fashioning the remaining dental compound.

The protrusions 28 are produced from an elastic material, such that it is possible to reduce the receiving spaces 29 again by applying a suitable pressure on the protrusions 28 in order to dispense part of the dental compound again from the receiving spaces 29, if required.

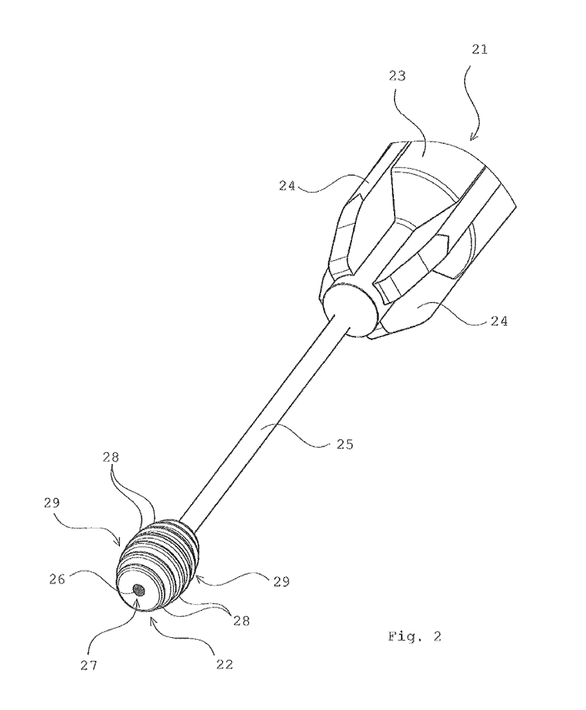

In the embodiment of FIG. 1, the protrusions 28 have identical dimensions. On account of the disk-shaped protrusions 28 being arranged behind one another, a contour in the shape of a cylinder results overall. In FIG. 2, the protrusions 28 pointing in the direction of the rear end 21 and the front end 22 have smaller diameters than the central protrusions 28. The contour defined by the protrusions 28 therefore tapers off in the direction of the rear end 21 and the front end 22. The embodiment according to FIG. 2 can be used, for example, to directly deposit the dental compound in cavities of teeth.

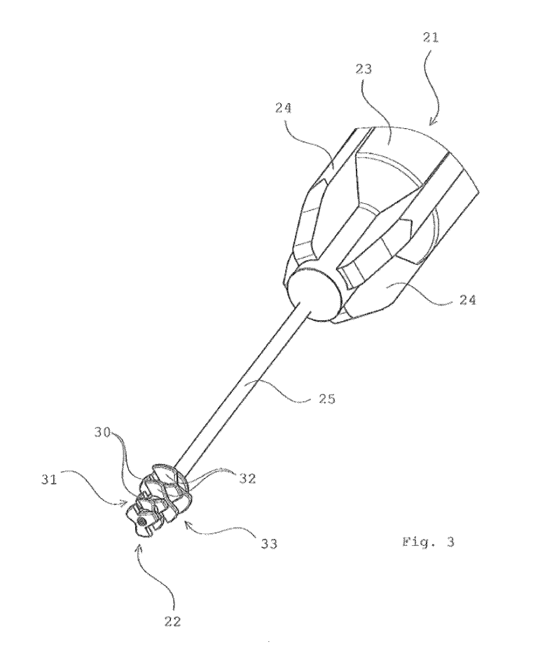

FIG. 3 shows an embodiment of the invention in which the receiving spaces are arranged in an offset manner against one another. Accordingly, two protrusions 30, which enclose between them a receiving space 31, are configured on the left side in FIG. 3. On the right side of the application device in FIG. 3, two protrusions 32, which enclose between them a receiving space 33, are likewise configured. The receiving spaces 31, 33 are offset against one another such that the protrusion 30 of the left receiving space 31 is arranged in the lateral extension of the right receiving space 33. Conversely, the protrusion 32 of the right receiving space 33 is arranged in the lateral extension of the left receiving space 31. This combination of receiving spaces which are arranged offset against one another is repeated several times. Collectively, the receiving spaces 31, 33 extend in an encircling manner around the shaft 25. When viewing the projection, the protrusions 30 of the left receiving space 31 terminate with the protrusions 32 of the right receiving space 33.

An intermediate protrusion, the surface area of which is smaller than the surface area of the protrusions 30, 32, is configured in each case in the receiving spaces 31, 33. However, the intermediate protrusion protrudes farther in the radial direction than the protrusions 30, 32. In the case of the present embodiment it is, in the example of the receiving space 33, not only the protrusions 32, which form the receiving space 33, by which the dental compound is retained in the receiving space 33. Rather, the protrusion 30, which lies in the lateral extension of the receiving space 33, contributes toward retaining the dental compound. The retention of the dental compound is further supported by the intermediate protrusion which is arranged in the center of the receiving space 33. It has transpired that this embodiment offers a high level of user friendliness.

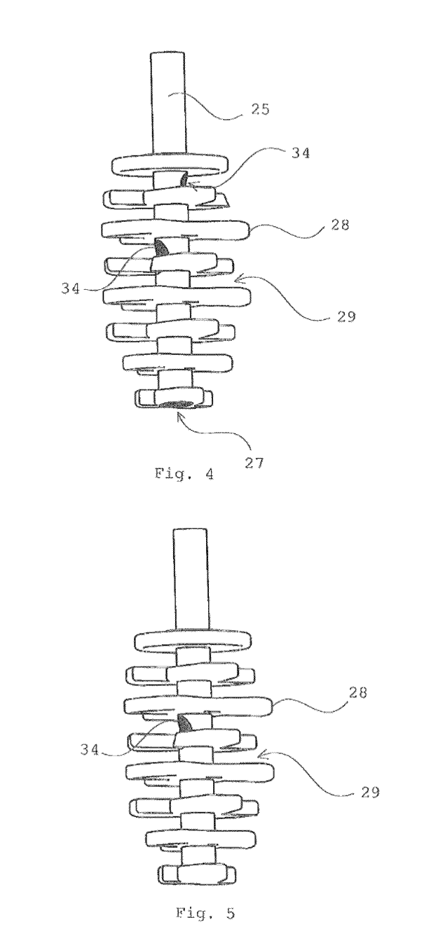

In FIGS. 4 and 5, the flat protrusions 28 have a similar shape as in FIG. 3. Except for one duct opening 27 on the end face of the support structure, two further duct openings 34, which open out laterally in relation to the longitudinal direction of the duct 26, are provided in FIG. 4. The duct openings 27, 34 open out into receiving spaces 29, such that dental compound exiting from the duct openings 27, 34 initially fills up the receiving spaces 29. From the receiving spaces 29, the dental compound can be dispensed and distributed in a targeted manner. In the event that too much dental compound has been dispensed unintentionally, receiving spaces, into which no duct opening 27, 34 opens out and in which therefore no dental compound is retained, can be used for retrieving the excess dental compound again. In FIG. 5, there is merely one single lateral duct opening 34.

1. An application device for dental compounds, having a connector, arranged on a rear end for a discharging container, and a duct which extends from the connector up to a duct opening which is arranged on the a front end, characterized in that flat protrusions, which enclose between them a receiving space for the dental compound, are configured on the front end and in that the flat protrusions are configured to be elastic.

2. (canceled)

3. The application device as claimed in claim 1, characterized in that a support structure, which extends to the front end, is provided and in that the support structure has a higher rigidity than the flat protrusions.

4. The application device as claimed in claim 3, characterized in that the application device is manufactured as an injection-molded part from a plastic material and in that the plastic material of the support structure has a higher rigidity than the plastic material of the flat protrusions.

5. The application device as claimed in claim 1, characterized in that a plurality of duct openings is provided.

6. The application device as claimed in claim 1, characterized in that the duct opening opens out into a receiving space.

7. The application device as claimed in claim 1, characterized in that the duct opening opens out outside of a receiving space.

8. The application device as claimed in claim 1, characterized in that the duct opening is arranged on a front end face of the application device.

9. The application device as claimed in claim 1, characterized in that the duct opening opens out laterally in relation to the direction of the duct.

10. The application device as claimed in claim 1, characterized in that the flat protrusions extend in the radial direction.

11. The application device as claimed in claim 1, characterized in that the flat protrusions extend forward from a front end of a support structure.

12. The application device as claimed in claim 1, characterized in that the connector comprises a conically tapered recess.

13. The application device as claimed in claim 1, characterized in that more than two flat protrusions, which enclose between them a plurality of receiving spaces, are provided.

14. The application device as claimed in claim 1, characterized in that the protrusions extend in a disk-shaped manner around the duct.

15. The application device as claimed in claim 1, characterized in that a first receiving space and a second receiving space are arranged in an offset manner against one another such that a protrusion of the first receiving space is arranged in the lateral extension of the second receiving space.

16. The application device as claimed in claim 3, characterized in that a plurality of duct openings is provided.

17. The application device as claimed in claim 4, characterized in that a plurality of duct openings is provided.

18. The application device as claimed in claim 3, characterized in that the duct opening opens out into a receiving space.

19. The application device as claimed in claim 4, characterized in that the duct opening opens out into a receiving space.

20. The application device as claimed in claim 5, characterized in that the duct opening opens out into a receiving space.

21. The application device as claimed in claim 2, characterized in that the duct opening opens out outside of a receiving space.
